(19) United States
(12) Patent Application Publication
(10) Pub. No.: US 2009/0113157 A1
(43) Pub. Date: Apr. 30, 2009

(54) INITIALIZING CIRCUIT FOR SEMICONDUCTOR MEMORY DEVICE HAVING BANK ACTIVE CONTROL CIRCUIT

(75) Inventors: Shinichi MIYATAKE, Tokyo (JP); Kenichi TANAMACHI, Fukuoka (JP)

Correspondence Address: SUGHRUE MION, PLLC, 2100 PENNSYLVANIA AVENUE, N.W., SUITE 800, WASHINGTON, DC, 20037, US

(73) Assignee: Elpida Memory, Inc., Tokyo (JP)

(21) Appl. No.: 12/258,000

(22) Filed: Oct. 24, 2008

(30) Foreign Application Priority Data
Oct. 26, 2007 (JP) 2007-279517

(51) Int. Cl. G06F 12/00

(52) U.S. Cl. 711/166; 711/E12.001

(57) ABSTRACT

An initializing circuit initializing a semiconductor memory device includes a command generating circuit generating a mode register set command in response to a reset command signal, a mode register set control circuit producing a reset signal in response to the mode register set command, and a bank active control circuit resetting the semiconductor memory device by generating an all-bank precharge command in response to the reset signal.

This application is based upon and claims the benefit of priority from Japanese patent application No. 2007-279517, filed on Oct. 26, 2007, the disclosure of which is incorporated herein in its entirety by reference.

### BACKGROUND OF THE INVENTION

1. Field of the Invention

This invention relates to an initializing circuit and an initializing method for a semiconductor memory device, and more particularly, to an initializing circuit and an initializing method for carrying out the semiconductor memory device by means of a mode register set (MRS) command.

2. Description of Related Art

In the manner which is well known in the art, a DDR2-SDRAM (Double-Data-Rate2 Synchronous Dynamic Random Access Memory) is a kind of standards of DRAMs each comprising a semiconductor integrated circuit. Hereinunder, the DDR2-SDRAM may be merely called “DDR2.”

The DDR2-SDRAM has a 4-bits prefetch function (namely, a function for outguessing and fetching data from a memory before a CPU requires the data) and uses, as an external clock signal, a clock signal having a frequency which is twice that of an internal clock signal. Therefore, in theory, the DDR2-SDRAM has a data transfer rate which is twice that of a DDR-SDRAM operable at the same clock signal and which is four times that of a SDRAM. In a personal computer, the DDR2-SDRAMs are available from 2004 and are in vogue for memory connection standards in the market after 2006.

In addition, the DDR-SDRAM has an operation power voltage of 2.5 volts/2.6 volts while the DDR2-SDRAM has another operation power voltage of 1.8 volts. Therefore, the DDR2-SDRAM realizes reduction of consumed power and reduction of heating.

Immediately after turning-on of the power (power-on), the DDR2-SDRAM comprises an internal circuit whose logic state is undefined. Accordingly, in order to ensure a normal operation, it is necessary to carrying out initialization of the DDR2-SDRAM. That is, in the DDR2-SDRAM (DDR2), inasmuch as there is any node within the semiconductor memory device that is put into an undefined state immediately after the power-on, there is a possibility that an active (ACT) signal becomes a logic “H” level so that the semiconductor memory device is put into a bank active state.

Consequently, in the DDR2-SDRAM, an initial sequence immediately after the power-on is defined so that all-bank precharging operation is carried out by input of a command and thereafter auto-refresh (REF) operation is carried out twice.

Various initializing circuits for semiconductor memory devices related to this invention are already proposed. By way of illustration, Japanese Unexamined Patent Application Publication of Tokkai No. 2007-95278 or JP-A 2007-95278 (which will be also called Patent Document 1), which corresponds to U.S. Patent Application No. US 2007/0070727, discloses a reset control circuit for a semiconductor memory device that prevents an error in accordance with a reset operation of a system. The reset circuit for the semiconductor memory device disclosed in Patent Document 1 comprises a reset signal generator for generating a reset entry signal and a reset exit signal respectively in response to a start timing and a termination timing of a reset operation of the system, and a reset controller for performing a precharge operation in response to the reset entry signal and a refresh operation in response to the reset exit signal. However, Patent Document 1 neither discloses nor teaches to carry out reset (initialization) of the semiconductor memory device by a mode register set (MRS) command.

### SUMMARY

The present invention seeks to solve one or more of the above problems, or to improve upon those problems at least in part.

In one embodiment, there is provided an initializing circuit initializing a semiconductor memory device. The initializing circuit comprises a command generating circuit generating a mode register set command in response to a reset command signal, a mode register set control circuit producing a reset signal in response to the mode register set command, and a bank active control circuit resetting the semiconductor memory device by generating an all-bank precharge command in response to the reset signal.

### BRIEF DESCRIPTION OF THE DRAWINGS

The above feature and advantages of the present invention will be more apparent from the following description of certain preferred embodiments taken in conjunction with the accompanying drawing, in which:

FIG. 1 is a time chart showing an initial sequence immediately after power-on of DDR2;

FIG. 2 is a block diagram of a reset path of the DDR2;

FIG. 3 is a block diagram of a reset path of a mode register set (MRS) command in a related LPDDR2;

FIG. 4 is a block diagram showing an initializing circuit according a first exemplary embodiment of this invention;

FIG. 5 is a time chart of an initial sequence by the initializing circuit illustrated in FIG. 4;

FIG. 6 is a block diagram showing an example of a shared path within an ACT control circuit for use in the initializing circuit illustrated in FIG. 4; and

FIG. 7 is a block diagram showing another example of a shared path within the ACT control circuit for use in the initializing circuit illustrated in FIG. 5.

### DETAILED DESCRIPTION OF PREFERRED EMBODIMENTS

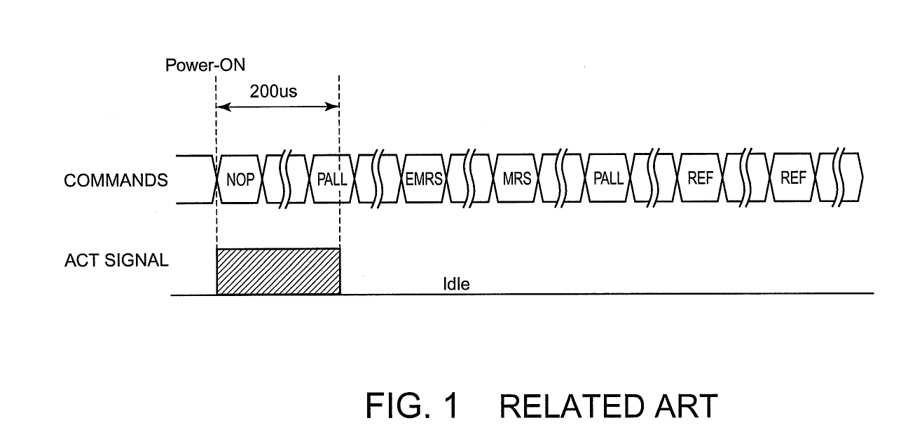

Before describing of the present invention, the related arts will be explained in detail with reference to FIGS. 1 though 3 in order to facilitate the understanding of the present invention.

FIG. 1 is a view for use in describing an initial sequence immediately after power-on for a DDR2-SDRAM.

Illustrated in FIG. 1, commands are as follows. A no-operation (NOP) command shows a command which does not give any change so as to continue a current carrying out operation. An all-bank precharge (PALL) command shows a command for stating precharge of all banks. An extended mode register set (EMRS) command shows a command for setting an operation mode of a DLL (delay locked loop). A mode register set (MRS) command shows a command for setting an operation mode such as a latency, a burst sequence, a burst length, a DLL reset, and so on. An auto refresh (REF) command shows a command for starting an auto refresh.

More specifically, immediately after the power-on, the no-operation (NOP) command is supplied. At the same time, a bank active (ACT) signal becomes a logic ‘H’ level. After a lapse of two hundreds microseconds from a time instant of the power-on, precharging of all banks is carried out using the all-bank precharge (PALL) command. At the same time, the bank active (ACT) signal becomes a logic ‘L’ level so as to become an idle state.

Subsequently, the extended mode register set (EMRS) command causes the DLL to enable to use. Then, the mode register set (MRS) command cause the DLL to reset. And, after the prechaging of all banks is carried out using the all-bank precharge (PALL) command, the auto refresh (REF) commands are supplied twice or more times.

In the manner which is describe above, in the DDR2, the initial sequence resets an undefined state within the semiconductor memory device by supplying, as the commands, the all-bank precharge (PALL) command and the auto refresh (REF) commands.

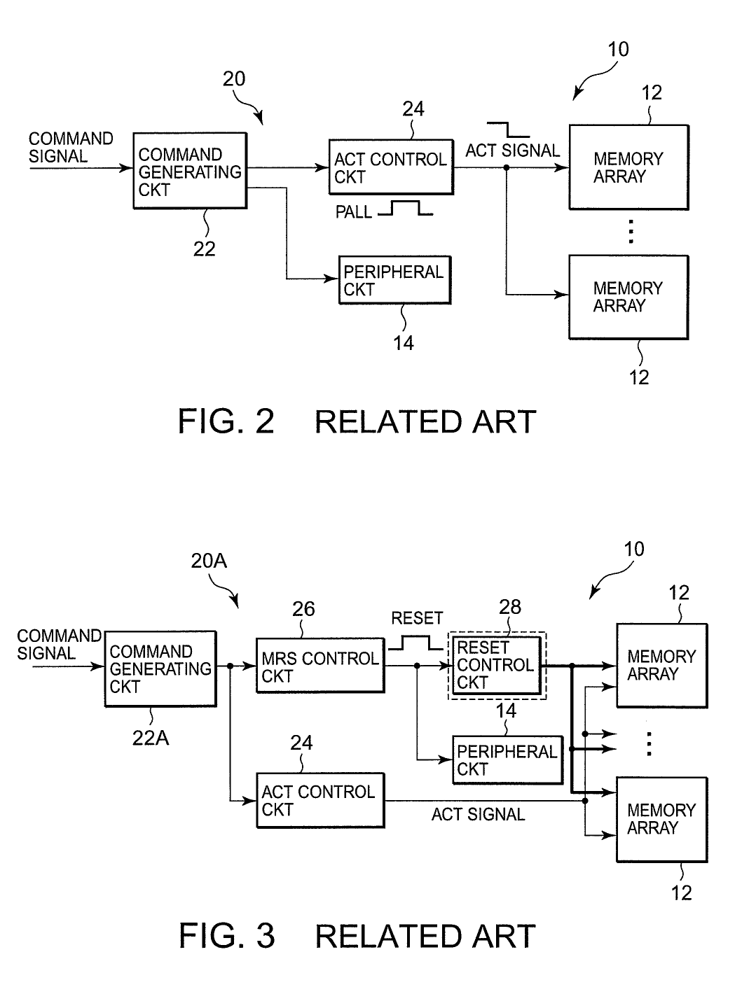

FIG. 2 is a block diagram of a reset path of the DDR2. In FIG. 2, a semiconductor memory device 10 comprises a plurality of memory arrays 12 and a peripheral circuit 14. On the other hand, an initializing circuit 20 for initializing the semiconductor memory device 10 comprises a command generating circuit 22 and a bank active (ACT) control circuit 24. In addition, the ACT control circuit 24 is also called a word line control circuit. Herein, in a normal mode, the ACT (word line) control circuit 24 is a circuit which activates an ACT signal in response to an ACT command supplied from the outside to set up a predetermined word line and which inactivates the ACT signal in response to a precharge command supplied from the outside to inactivate the above-mentioned word line.

Supplied with a command signal, the command generating circuit 22 starts the ACT control circuit 24. Hence, the ACT control circuit 24 generates the all-bank precharge (PALL) command so as to cause the bank active (ACT) signal the logic ‘L’ level, thereby carrying out reset in the memory arrays 12.

On the other hand, a LPDDR2-SDRAM (low-Power Double-Data-Rate2 Synchronous Dynamic Random Access Memory) is used as a DRAM which is capable of expecting a higher-speed and lower-voltage operation than the DDR2-SDRAM. Hereinafter, the LPDDR2-SDRAM may be merely called “LPDDR2.” In the LPDDR2, command input of the all-bank precharge (PALL) command and the auto refresh (REF) commands is not carried out and reset of the semiconductor memory device is carried out using the mode register set (MRS) command. In the manner which is described above, the LPDDR2 has a simplified sequence for reset operation as compared with the above-mentioned DDR2.

FIG. 3 shows a block diagram of a reset path of the mode register set (MRS) command in the LPDDR2. In FIG. 3, the semiconductor memory device 10 comprises the plurality of memory arrays 12 and the peripheral circuit 14. On the other hand, an initializing circuit 20A for initializing the semiconductor memory device 10 comprises a command generating circuit 22A, the bank active (ACT) control circuit 24, a mode register set (MRS) control circuit 26, and a reset control circuit 28. Herein, the mode register set (MRS) control circuit 26 is a circuit which generates a reset signal in response to a mode register set (MRS) command supplied from the command generating circuit 22A.

When the semiconductor memory device 10 is reset using the mode register set (MRS) command, the command generating circuit 22A first receives a reset command signal. Responsive to the reset command signal, the command generating circuit 22A issues or generates the mode register set (MRS) command. The mode register set (MRS) command is supplied to the MRS control circuit 26. Responsive to the mode register set (MRS) command, the MRS control circuit 26 produces a reset signal RESET. The reset signal RESET is supplied to the reset control circuit 28 and the peripheral circuit 14. Responsive to the reset signal RESET, the reset control circuit 28 carries out reset in the memory arrays 12.

In the manner which is described above, in the LPDDR2-SDRAM (the LPDDR2), initialization of the semiconductor memory device 10 must be carried out by carrying out the reset of the semiconductor memory device 10 using the mode register set (MRS) command once without the command input such as the all-bank precharge (PALL) command and the auto refresh (REF) commands in the DDR2.

However, in the initializing circuit 20A illustrated in FIG. 3, there is a node which is impossible to reset using the mode register set (MRS) command when an undefined state remains in the semiconductor memory device 10. As a result, there is a possibility that a device (the semiconductor memory device 10) does not normally operate. In addition, when the reset of the semiconductor memory device 10 is carried out by means of the reset signal RESER using the mode register set (MRS) command, it is feared that redundant wires and logics increase in order to reset all latch circuits within the semiconductor memory device 10 as a thick area of FIG. 3.

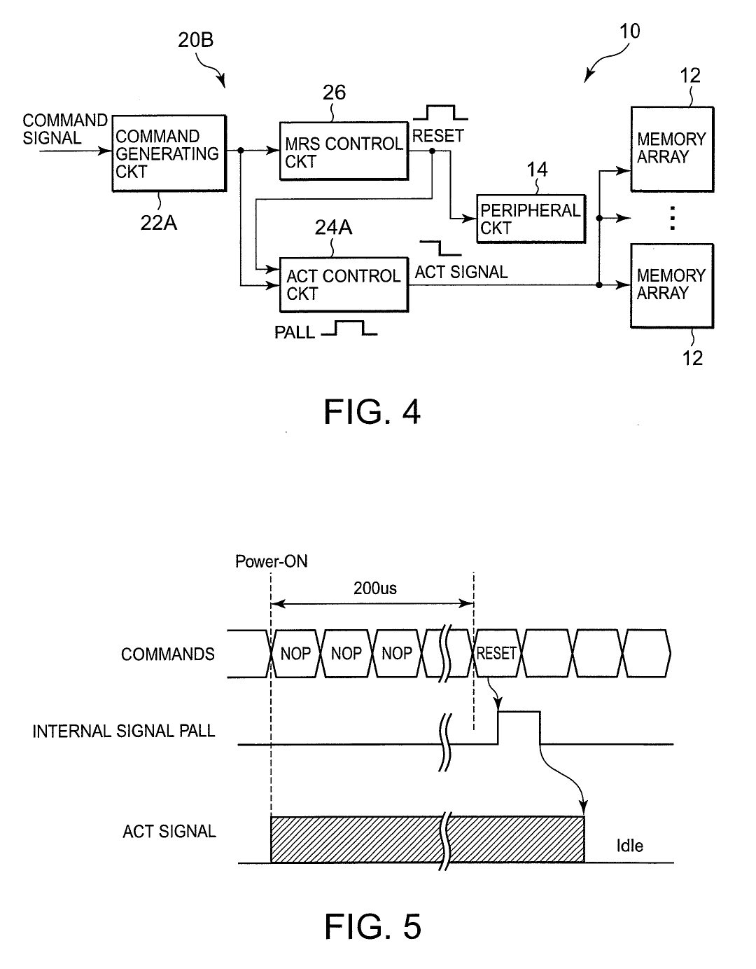

Referring to FIG. 4, the description will proceed to an initializing circuit 20B for the semiconductor memory device 10 according to a first embodiment of the present invention.

The semiconductor memory device 10 comprises the plurality of memory arrays 12 and the peripheral circuit 14.

The initializing circuit 20B comprises the command generating circuit 22A, the MRS control circuit 26, and an ACT (word line) control circuit 24A. Herein, in a normal mode, the ACT (word line) control circuit 24A is a circuit which activates an ACT signal in response to an ACT command supplied from the outside to set up a predetermined word line and which inactivates the ACT signal in response to a precharge command supplied from the outside to inactivate the above-mentioned word line. In addition, the mode register set (MRS) control circuit 26 is a circuit which generates a reset signal in response to a mode register set (MRS) command supplied from the command generating circuit 22A.

In other words, the illustrated initializing circuit 20B is similar in structure to the initializing circuit 20A illustrated in FIG. 3 except that the ACT control circuit 24 is modified into the ACT control circuit 24A and the reset control circuit 28 is omitted.

Reset (Initialization) of the semiconductor memory device 10 by means of the mode register set (MRS) command will be carried out as follows. When the command generating circuit 22A receives a reset command signal, the command generating circuit 22A issues or generates the mode register set (MRS) command. Supplied with the mode register set (MRS) command, the MRS control circuit 26 produces the reset signal RESET.

Thereafter, the reset signal RESET is supplied to the peripheral circuit 14 and the ACT control circuit 24A. Reset of the peripheral circuit 14 is carried out by the reset signal RESET. On the other hand, the ACT control circuit 24A generates the all-bank precharge (PALL) command therein to carry out reset in the memory arrays 12.

Referring to FIG. 5 showing a time chart of an initial sequence, the description will be made as reset (initialization) of the semiconductor memory device 10 by means of the mode register set (MRS) command according to the first embodiment of the present invention.

In the initial sequence immediately after the power-on, after a lapse of two hundreds microseconds from the power-on, the reset of the semiconductor memory device 10 is carried out by means of the mode register set (MRS) command. Responsive to the reset signal RESET from the MRS control circuit 26, the ACT control circuit 24A automatically generates the all-bank precharge (PALL) command therein to carry out the reset in the memory arrays 12.

Accordingly, in the initial sequence of the LPDDR2, as illustrated in FIG. 5, concurrently with input of the reset signal by means of the mode register set (MRS) command, the ACT control circuit 24 generates the all-bank precharge (PALL) command therein to precharge all of banks. It results in getting rid of the nodes which are put into the undefined state in the memory arrays 12 and it is possible to insure normal operation of the semiconductor memory device 10.

Inasmuch as the initializing circuit 20A illustrated in FIG. 3 newly constructs a path for reset (wires for connecting between the reset control circuit 28 and the memory arrays 12), a lot of redundant logics and wires is required. As compared with this, inasmuch as the initializing circuit 20B illustrated in FIG. 4 uses an existing path for the all-bank precharge (PALL) command, it is possible to minimize increase of logics and wires.

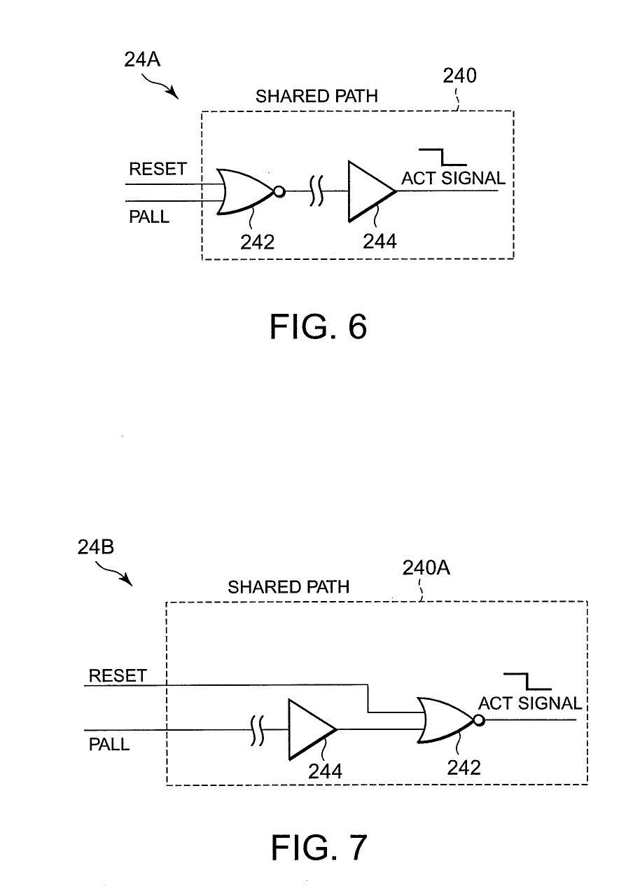

FIG. 6 shows a shared path 240 in the ACT control circuit 24A according to an embodiment of this invention. The shared path 240 includes a NOR gate 242 and a driver 244.

In the ACT control circuit 24A, in order to share the existing path for the all-bank precharge (PALL) command as shown in FIG. 6, the NOR gate 242 takes a NOR operation between the all-bank precharge (PALL) command and the reset signal RESET.

In the manner which is described above, in the initial sequence immediately after the power-on of the semiconductor memory device 10, by automatically carrying out the all-bank precharge (PALL) command on carrying out the reset (the initialization) of the semiconductor memory device 10 by means of the mode register set (MRS) command, it is possible to get rid of the nodes which are put into the undefined state in the semiconductor memory device 10. In addition, by sharing the existing path for the all-bank precharge (PALL) command, it is possible to restrain the redundant logics and wires.

Although the shared path 240 in the ACT control circuit 24A is implemented by taking the NOR operation in the NOR gate 242 between the reset signal RESET for the mode register set (MRS) command and the all-bank precharge (PALL) command in the embodiment illustrated in FIG. 6, sharing of the path is not limited to this.

FIG. 7 shows a shared path 240A in the ACT control circuit 24B according to another embodiment of this invention. The shared path 240A includes the NOR gate 242 and the driver 244. In the other embodiment illustrated in FIG. 7, the shared path 240A is implemented by taking a NOR operation in the NOR gate 242 between the reset signal REST for the mode register set (MRS) command and an output signal of a shared path portion (an output signal of the driver 244 for receiving the all-bank precharge (PALL) command).

It is apparent that the present invention is not limited to the above embodiments, but may be modified and changed without departing from the scope and spirit of the invention. For example, although the bank active control circuit comprises the NOR gate for taking the NOR operation the reset signal for the mode register set (MRS) command and the all-bank precharge (PALL) command in the above-embodiments, other logic circuits may be used in the bank active control circuit.

What is claimed is:

1. An initializing circuit initializing a semiconductor memory device, said initializing circuit comprising:
a command generating circuit generating a mode register set command in response to a reset command signal;
a mode register set control circuit producing a reset signal in response to the mode register set command; and
a bank active control circuit resetting said semiconductor memory device by generating an all-bank precharge command in response to the reset signal.

2. The initializing circuit as claimed in claim 1, wherein said bank active control circuit activates an ACT signal in response to an ACT command and inactivates said ACT signal in response to a precharge command in a normal mode.

3. The initializing circuit as claimed in claim 2, further comprising a plurality of memory banks, and wherein
said all-bank precharge command in response to the reset signal is supplied to said plurality of memory banks through a same path supplying said precharge command in said normal mode to said plurality of memory banks.

4. The initializing circuit as claimed in claim 1, wherein said bank active control circuit includes an NOR gate for carrying out an NOR operation between the reset signal and the all-bank precharge command, thereby resetting said semiconductor memory device by an output signal of said NOR gate.

5. A method of initializing a semiconductor memory device, said method comprising:
generating a mode register set command in response to a reset command signal;
producing a reset signal in response to the mode register set command; and
resetting said semiconductor memory device by generating an all-bank precharge command in response to the reset signal.

6. The method as claimed in claim 5, wherein said resetting step resets said semiconductor memory device by a signal obtained by carrying out an NOR operation between the reset signal and the all-bank precharge signal.
